(19) United States
(12) Patent Application Publication
(10) Pub. No.: US 2013/0104659 A1
(43) Pub. Date: May 2, 2013

(54) Method for Non-Destructive Testing

(71) Applicants: James E. PARKER, Columbia, MO (US); Clyde O. ADAMS, III, Kingwood, TX (US)

(72) Inventors: James E. PARKER, Columbia, MO (US); Clyde O. ADAMS, III, Kingwood, TX (US)

(73) Assignee: Amerapex Corporation, Houston, TX (US)

(21) Appl. No.: 13/553,490

(22) Filed: Jul. 19, 2012

Related U.S. Application Data
(60) Provisional application No. 61/551,558, filed on Oct. 26, 2011.

(51) Int. Cl. G01N 29/04

(52) U.S. Cl. 73/627

(57) ABSTRACT

At least one location on a component is to be inspected by performing non-destructive testing. The components to be tested typically include piping and plate materials or a structural component. The components to be tested are typically storage and transmission components. A guided wave probe is installed on the component at the at least one location. A wave is transmitted a along the component. A reflected wave is analyzed to determine if a fault or damage condition exists or if a specific geometric feature, which is unable to be seen visually, is present. A location of the condition is determined based on the analysis. A localized test at the location is performed to determine structural integrity. The location is marked and its respective condition is recorded for follow-up analysis. The follow-up analysis is performed at the location for the respective condition.

### RELATED APPLICATIONS

This application claims priority from U.S. Provisional Patent Application Ser. No. 61/551,558 which was filed on Oct. 26, 2011.

### BACKGROUND OF THE INVENTION

1. Field of the Invention

The present invention relates generally to a method for ongoing evaluation of pipes utilizing non-destructive evaluation. The present invention relates more specifically to a magnetostrictive sensor based system for among other things the long-term evaluation of corrosion of pipes and degradation of welds.

2. Description of the Related Art

Structural components such as piping in a refinery or chemical processing plant depend upon a maintenance schedule to verify component integrity. During operation of a facility, pipes suffer from corrosion. Testing for such corrosion is an expensive and time-consuming endeavor.

Various techniques are used to investigate and monitor the integrity of such structural components. Non-Destructive Evaluation (NDE) techniques are typically used to investigate and monitor the structural components. The most widely used NDE techniques are ultrasonic testing and magnetic flux testing for ferromagnetic steel pipes.

Current mechanical equipment NDE techniques are based primarily on ultrasonic testing methods and test equipment. Ultrasonic testing is applied to a small diameter area of an outer surface of a pipe, plate, rod, cable, casting, or other structural component. An injected sound wave is reflected and any anomalies located immediately under the test point are detected. A receiver analyzes the reflected wave and determines distance (thickness) and signal strength. Ultrasonic testing is effective for determining metal thickness, and if the same spot is examined over a long period of time, ultrasonic testing can be used to predict long term wear. This test is typically used to determine a corrosion rate for the structural component. However, ultrasonic testing is not very effective for detecting defects such as cracks, slag, impurity inclusions inside the metal, or localized pitting corrosion without performing an excessive number of tests.

Ultrasonic testing relies on selecting several hundred testing points at various locations along a pipe and testing each of these points to determine if there is a defect or corrosion present. The large number of test points is due to the narrow range of ultrasonic testing. Ultrasonic testing is only effective if the testing is performed at the exact location where there is a defect or corrosion. If the defect or corrosion is at a location that is not tested, it will not be detected. Additionally, ultrasonic testing typically required extensive temporary scaffolding to be erected during the testing. Thus, ultrasonic testing can be very expensive and may not locate defects or corrosion.

Magnetic flux testing of ferromagnetic steel pipes comprises magnetizing a pipe and checking for aberrations in the magnetic flux. Magnetizing the pipe is complex once it is installed because it cannot be moved or rotated to be magnetized. Thus, magnetic flux testing cannot easily be used to detect corrosion in an installed pipe.

What is needed is an economical long-term inspection method using NDE that can identify defects and corrosion.

### SUMMARY OF THE INVENTION

According to one embodiment of the invention, non-destructive testing of mechanical equipment utilizes magnetostrictive sensor-based guided wave test equipment to provide comprehensive detection of defects in various components. The component is typically one of a structural component, a pipe, a cable, a plate, and a tank. The test equipment is commercially available, and currently utilized primarily in unique instances to locate known defects or defects in industrial plant equipment when other methods are inadequate or inaccurate.

The inventive method utilizes the magnetostrictive sensor-based guided wave test equipment in a routine program to comprehensively examine entire facilities or pieces of equipment for defects. Any located defects will be further examined with other methods, and appropriate action taken.

In one embodiment, an entire length of pipe is tested with a single magnetostrictive sensor. Using magnetostrictive sensor-based guided wave test equipment, an exact defect position is determined. If the test result indicated a potential area of corrosion or other defect, the exact location of the defect is marked for further tested using ultrasonic testing or the like. The defect location is also marked for follow-up testing or remedial action. The efficiency of testing is greatly improved because hundreds of ultrasonic test points are eliminated and each ultrasonic test is performed at an area that is indicated as being problematic.

An advantage of the inventive method is that actual problems are identified for further monitoring. Random testing that may or may not identify a potential problem is eliminated.

According to one embodiment, the method comprises determining at least one location on a component to be inspected for performing non-destructive testing. The components to be tested typically include piping and plate materials or a structural component. The components to be tested typically are storage and transmission components. A guided wave probe is installed on the component at the at least one location. A wave is transmitted a along the component. A reflected wave is analyzed to determine if a fault or damage condition exists or if a specific geometric feature, which is unable to be seen visually, is present. A location of the condition is determined based on the analysis. A localized test at the location is performed to determine structural integrity. The location is marked and its respective condition is recorded for follow-up analysis. The follow-up analysis is performed at the location for the respective fault condition.

In one embodiment, testing to determine if a condition exists is performed at scheduled intervals of a first duration. The testing to determine integrity is typically an ultrasonic test. The follow-up analysis is also an ultrasonic test. The follow-up analysis is performed at intervals of a second duration. Typically, the first duration is longer than the second duration.

### BRIEF DESCRIPTION OF THE FIGURES

FIG. 1 is a system that uses one embodiment of the method; and

FIG. 2 is a flowchart of one embodiment of the invention.

### DETAILED DESCRIPTION

An equipment owner must assure regulatory agencies, workers, and the public that the plant equipment is safe to operate and to be near. Typically, a staff of inspection personnel is maintained whose sole duty is to monitor, using ultrasonic test equipment, all of the selected test points according to a routine, published schedule. A refinery, for example, may have several tens of thousands of points to monitor, record, track, and analyze at intervals ranging from weekly to annually. New corrosion or defects that develop away from the selected test points will rarely be detected until serious problems develop.

The guided wave test equipment comprehensively examines a large piece of equipment such as an entire pipe 10 from a single point, and accurately locates and identifies defects in the piece of equipment. The defect is then more closely examined by ultrasonic or other testing methods to determine severity of the defect and to determine a corrective course of action. Note that the entire piece of equipment is examined for defects, and not just the small area under the randomly selected point previously employed.

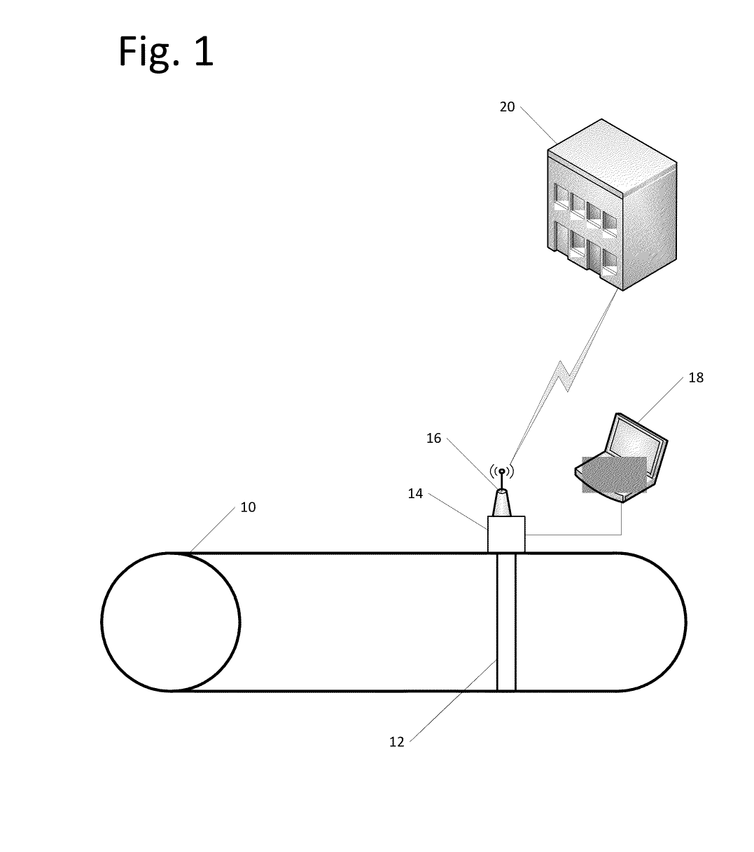

FIG. 1 is one embodiment of the invention where a length of pipe 10 is shown under test. The guided wave test equipment 12 is positioned at critical process locations determined by the severity of a failure. Other locations are selected based at least in part on process analysis, risk based inspection, and, with respect to pipes, areas where thinning is an issue.

As shown, guided wave test equipment 12 is affixed to a section of pipe 10. While a pipe 10 is shown in FIG. 1, the component under test can be a plate, pipe, vessel, beam, or the like. A control unit 14 is shown schematically. In one embodiment, a wireless transmitter 16 transmits data from the guided wave test equipment 12 to a central monitoring station 20. It should be noted in a refinery or other location there can be many test points and each of these test points can provide data to the central monitoring station 20. The data can be transmitted wirelessly via a cellular network of over the Internet, or the like. Further, the central monitoring station 20 can monitor multiple refineries and/or multiple locations. For local data acquisition, test equipment 18 can be coupled to the control unit 14. A user would typically move the test equipment 18 to each of the test points in an installation to acquire test data for each test point.

In order for ultrasonic testing to be used as a preventative measure, the piece of equipment must be exposed at each location to be tested. In other words, the insulation must be removed from the pipe or, if the pipe is buried, the pipe must be excavated at multiple locations. In contrast, using guided wave testing, only a single convenient portion of the structural component or pipe 10 is exposed. Guided wave testing provides for the entire structural component or pipe to be tested.

The guided wave testing equipment 12, 14 allows a single operator to examine 100% of the metal volume in a piece of mechanical equipment for defects, and to then place only that defective area into a close scrutiny program for monitoring, tracking, and corrective action. Only the defective area needs to be closely monitored and all other areas that show no defects can be safely eliminated from the intensive watch program. This represents a savings of large amounts of inspection manpower, craft manpower, equipment rentals, testing equipment, and other valuable resources. Further, it provides assurance that the entire piece of equipment is substantially free of unknown defects, instead of just the small volume represented by the test equipment's test point that is typically a fraction of a percent of the total equipment volume. Further, because entire pieces of equipment are tested at one time from a single set-up location on the equipment, and because a test can be completed in minutes, the inspection personnel become much more efficient, and can examine equipment at more frequent intervals if desired or required.

Like ultrasonic test points, test points for guided wave testing must be exposed and cleaned. The test area required for the transducer/detector is around a pipe or across a flat plate. Equipment temperature may require different set-ups. The set-up typically takes longer than opening an inspection port for an ultrasonic test because the entire circumference of a pipe must be exposed. Therefore, it is preferable that unless the set-up is left in place permanently for subsequent inspection cycles.

Using the present method, a refinery, chemical plant, or the like, is first analyzed to determine the most likely areas of corrosion. These locations are preferably subjected to guided wave testing. Once an area is identified, a magnetostrictive device is attached directly to the pipe or other element to be tested. Once attached, a test is performed. A pulse is sent down the pipe and discontinuities in the reflected pulse are analyzed to determine if the discontinuities represent corrosion. Discontinuities typically represent corrosion or other defect. If there are discontinuities, the reflected pulse is analyzed to determine an exact location of the discontinuity. This discontinuity is then tested using a second method such as ultrasonic testing. The discontinuity is then added to a follow-up schedule so that the discontinuity can be monitored to prevent a catastrophic failure.

The magnetostrictive device is preferably installed and used on a permanent or semi permanent basis. The inspection program using the present invention selects locations based on testing frequency and location.

Guided wave testing equipment allows for the comprehensive examination of all pipes, cables, plates, rods, or the like. This method changes the prior art random sample to a comprehensive full system test.

Once an initial test of the system is performed, defects are identified. These specific defects can then be cataloged and slated for follow-up testing or repair, as required.

The identification of potential discontinuities does not mean that a facility has to immediately correct the discontinuity. Further testing is preferably performed to determine the severity of the discontinuity. Industry guidelines specify when a pipe or other component must be replaced based on a measured discontinuity. The present method can more accurately determine the life expectancy of a pipe or other structural component.

In a first embodiment, testing is performed at each sensor. The testing equipment is brought to each sensor and one or more tests are run. In another embodiment, data is collected at a central corrosion inspection office located within an industrial plant or at a remote location. In one embodiment, the remote location monitors a plurality of installations. All of the data from each of the guided wave instrument transducer/detector sensors is sent to this central location. In a preferred embodiment, each test location provides identifying data to the test equipment or the central monitoring location. The present method provides for semicontinuous or fully continuous monitoring of all monitored equipment using a single device and a central computer system for data storage, analysis, and reporting.

The present method can also be used to monitor equipment installed during project construction to identify potential equipment defects in materials supplied by a vendor or possible errors like defective welding, bolting, heat treating, or other activities, which may occur during normal construction processes.

The present method can be used to monitor for defects, which might occur during equipment start-up following new construction, equipment shutdowns, or other planned or unplanned outages. The present method can also be used to inspect tank bottoms for corrosion without emptying and cleaning the tank.

The present testing and maintenance method streamlines the process for determining potential faults. Entire lengths of pipes are tested and a follow-up schedule for location specific testing can be determined from the initial testing. This combination of an initial guided wave test and subsequent location specific testing and long-term follow-up increases the efficiency of facility testing. The time to test is greatly reduced and the time consuming specific location testing, such as ultrasonic testing, is only performed at locations with known defects. In this manner, fewer people are required to perform the testing and less infrastructure is required because only defect locations are tested.

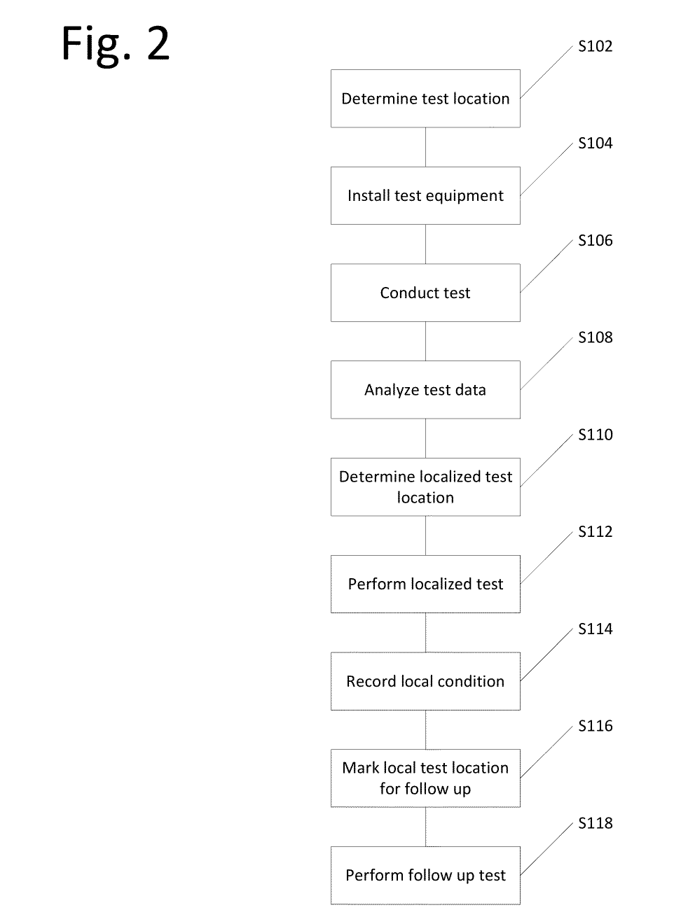

A flowchart of one embodiment of the invention is shown in FIG. 2. While the method is shown and described in the following order, the steps can be performed in other orders as required in a given situation. Initially, at least one location on the component is determined for performing non-destructive testing (S102). A guided wave probe is installed on the component at the at least one location (S104). Testing is performed by transmitting a wave along the component (S106). The results of the testing are analyzed to determine if a relevant indication exists (S108). The relevant indication can be a thinning of a pipe wall or the like. Based on the test results a location of the relevant indication is determined (S110). A localized test is performed at the determined location to determine structural integrity (S112). This localized test can be a local x-ray or ultrasound test. The location is marked and its respective condition recorded for follow-up analysis (S114, S116). The marking can occur locally on the component being tested or a plan for the overall structure. The follow up is scheduled to occur at an interval so that degradation at the location can be monitored. Specifically, the interval is chosen so that the condition can be monitored and the component can be repaired or replaced before a failure occurs. Finally, follow-up testing is performed at the determined location for the respective condition (S118).

Due to the follow up testing, repairs can be scheduled before a catastrophic failure occurs. Further, severity of any determined conditions can be monitored so that one or more conditions can be repaired at the same time. For installations such as refineries or chemical processing plants, repairs that require partial shutdowns can be performed simultaneously to minimize those shutdowns. In other words, multiple conditions along a pipe path can be repaired based during the same shutdown if the follow-up test results indicate that a failure is imminent.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

We claim:

1. A method for nondestructive testing of pipes comprising:
determining at least one location on a component for performing non-destructive testing;
installing a guided wave probe on the component at the at least one location;
transmitting a wave along the component;
analyzing a reflected wave to determine if a relevant indication exists;
determining a location of the relevant indication;
performing a localized test at the determined location to determine integrity at the determined location;
marking the determined location and its relevant indication for follow-up analysis; and
performing follow-up analysis at the determined location for the relevant indication.

2. The method of claim 1, wherein testing to determine if a fault condition exists at the determined location is performed at scheduled intervals of a first duration.

3. The method of claim 1, wherein the localized test to determine structural integrity is an ultrasonic test.

4. The method of claim 1, wherein the follow-up analysis is an ultrasonic test to determine structural integrity.

5. The method of claim 2, wherein the follow-up analysis is performed at intervals of a second duration.

6. The method of claim 5, wherein the first duration is longer than the second duration.

7. The method of claim 1, wherein the component is one of a pipe, a cable, a plate, and a tank.

8. The method of claim 1, wherein the component is at least part of a refinery.

9. The method of claim 1, further comprising permanently installing the guided wave probe on the component.

10. The method of claim 1, further comprising monitoring the guided wave probe at a central location.

11. The method of claim 10, wherein the central location is at least one of proximate to the component and remote from the component.

12. The method of claim 10, wherein the component is part of a first refinery and a plurality of refineries are monitored at a single central location.

13. The method of claim 11, wherein the guided wave probe is installed during construction of the component.

14. The method of claim 1, wherein the guided wave probe transmits identifying data and relevant indication data.

15. The method of claim 1, wherein the relevant indication is at least one of a fault condition, damage, and a geometric feature.
